(19) United States
(12) Patent Application Publication
(10) Pub. No.: US 2014/0102630 A1
(43) Pub. Date: Apr. 17, 2014

(54) MULTI-SURFACE APPLIQUEING METHOD FOR MELAMINE CONTAINER

(71) Applicant: Tsung-Han Tsai, New Taipei City (TW)

(72) Inventor: Tsung-Han Tsai, New Taipei City (TW)

(21) Appl. No.: 14/140,572

(22) Filed: Dec. 26, 2013

Related U.S. Application Data
(63) Continuation-in-part of application No. 12/892,908, filed on Sep. 28, 2010.

(51) Int. Cl. B32B 37/10

(52) U.S. Cl. CPC B32B 37/10
USPC 156/245

(57) ABSTRACT

A multi-surface appliqueing method is provided for producing a melamine container that has internal and external appliques performed with a single mold and a single machine. A proper amount of a raw material is placed in a mold including male and female molding members. The mold is heated and the male and female molding members are closed to mold the raw material as a product, with the temperatures of the male and female molding members being set in predetermined temperature ranges. The mold is then opened and an external applique layer is fit over the product and a glitter powder is spread, followed by closing the mold to proceed with external appliqueing of the product. The mold is opened again and an internal applique layer is placed on the male molding member and a glitter powder is spread, following closing the mold to proceed with internal appliqueing.

### CROSS-REFERENCE TO RELATED APPLICATION

This is a continuation-in-part of co-pending U.S. patent application Ser. No. 12/892,908 filed on Sep. 28, 2010 and owned by the present applicant.

### TECHNICAL FIELD OF THE INVENTION

The present invention generally relates to a melamine container, and more particularly to a multi-surface appliqueing method for a melamine container that achieves molding and inside and outside surface appliqueing of a melamine container with a single mold in a single processing machine.

### DESCRIPTION OF THE PRIOR ART

A regular melamine container that is currently available in the market, such as a bowl and a dish, is generally formed through a molding process carried out in a hydraulically operated processing machine with female and male molding members. Such a molded melamine container is of a single color. This makes the container monotonous and generally invariable in color. Thus, a so-call “appliqueing” process is often applied to an outside portion of the container, which attaches an applique layer or alphanumeric or other sings on an outer circumference of the container to make the container beautiful and valuable.

Conventionally, two sets of molds of different specifications are used with two processing machines. The first set of mold is arranged in the first processing machine to carry out a first appliqueing process for a first surface or portion of the container. The container is then removed out of the first set of mold and placed into the second set of mold that is arranged in the second processing machine to carry out a second round of material feeding and a second appliqueing operation to accomplish appliqueing of a second surface or portion of the container. Two-surface appliqueing is achieved with the use of two sets of mold that are of different specifications.

However, there are certain drawbacks existing in the appliqueing process performed with two molds and two processing machines:
(1) When a product is processed with the first mold in the first machine, the material of the product must be cured before it can be removed out of the first mold and further deposited into the second mold of the second machine; and since the material has been cured and hardened, it is no longer possible to re-shape the material and to re-melt the material for integral fusion.
(2) An applique decoration formed in this way is actually composed of two layers of coating, which are not integrally formed as a one-piece structure.
(3) Since the coating is not a one-piece structure, the product, when dropping or cleaned, is susceptible to cracking or peeling of the coating.
(4) Being susceptible to the influence of the ambient temperature variations or the temperature of a substance received therein, the product is affected by the different temperatures of the outside and inside of the product to have coating layer separated into two layers, thereby deteriorating the quality of the product.
(5) Using two machines is a waste of energy and labor.
(6) The conventional product has only one surface covered with resin-based glitter powders for hardening.

Thus, it is desired to provide a solution to overcome the above-discussed problems.

### SUMMARY OF THE INVENTION

In view of the above listed shortcomings of the existing techniques, the present invention aims to provide a multi-surface appliqueing method for a melamine container, which accomplishes molding and internally and externally appliqueing of a melamine container with a single mold.

The primary object of the present invention is to realize molding of a melamine container with a single mold and also the achieve external and internal appliqueing with the same mold, whereby with such a technique, the present invention can overcome the shortcomings of the known techniques that it is not possible to use a single machine to carry a second round of molding, coating can be readily peeled off and delaminated due to being not integrally formed, and a waste of time and human labor may result, and realize molding and external and internal appliqueing with a single mold.

To achieve the above object, the present invention provides a method, which comprises the following steps:
(a) placing a predetermined amount of raw material in a mold that comprises a male molding member included platform and a female molding member included platform, wherein the predetermined amount is selected according the mold used;
(b) heating the mold and performing a first round of mating and closing the male and female molding members in such a way that temperature of the male molding member and temperature of the female molding member are respectively set within predetermined ranges of temperature so as to proceed with molding of the raw material into a product through the first round of mating and closing the male and female molding members;
(c) performing a first round of mold opening and fitting an external applique layer over the product and performing a second round of mating and closing the male and female molding members to proceed with an external appliqueing operation of the product;
(d) performing a second round of mold opening and spreading a glitter powder on the external applique layer and performing a third round of mating and closing the male and female molding members to proceed with an external glittering operation of the product;
(e) performing a third round of mold opening, where the product is attached to the female molding member by adhesion resulting from the inclusion of the glitter powder on the external applique layer, and placing an internal applique layer on the male molding member and performing a fourth round of mating and closing the male and female molding members to proceed with an internal appliqueing operation of the product;
(f) performing a fourth round of mold opening and spreading a glitter powder on the male molding member and performing a fifth round of mating and closing the male and female molding members to proceed with an internal glittering operation of the product; and
(g) performing a fifth round of mold opening and removing the product that comprises the internal and external appliques out of the mold.

With such a method, the present invention can achieve appliqueing of internal and external surfaces of a product by using only a single machine and a single mold. As such, the problems of the known techniques (such as being impossible to use a single machine to carry out a second round of molding, coating being readily peeled off and delaminated due to being not integrally formed, and waste of time and human labor) can be overcome and molding and internal and external appliqueing can be performed with a single mold.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a flow chart illustrating a multi-surface appliqueing method for a melamine container according to a preferred embodiment of the present invention.

FIG. 2 is cross-sectional view illustrating a first stage of the method according to the present invention.

FIG. 3 is a cross-sectional view illustrating a second stage of the method according to the present invention.

FIG. 4 is a cross-sectional view illustrating a third stage of the method according to the present invention.

FIG. 5 is a cross-sectional view illustrating a fourth stage of the method according to the present invention.

FIG. 6 is a cross-sectional view illustrating a fifth stage of the method according to the present invention.

FIG. 7 is a cross-sectional view illustrating a sixth stage of the method according to the present invention.

FIG. 8 is a cross-sectional view illustrating a seventh stage of the method according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

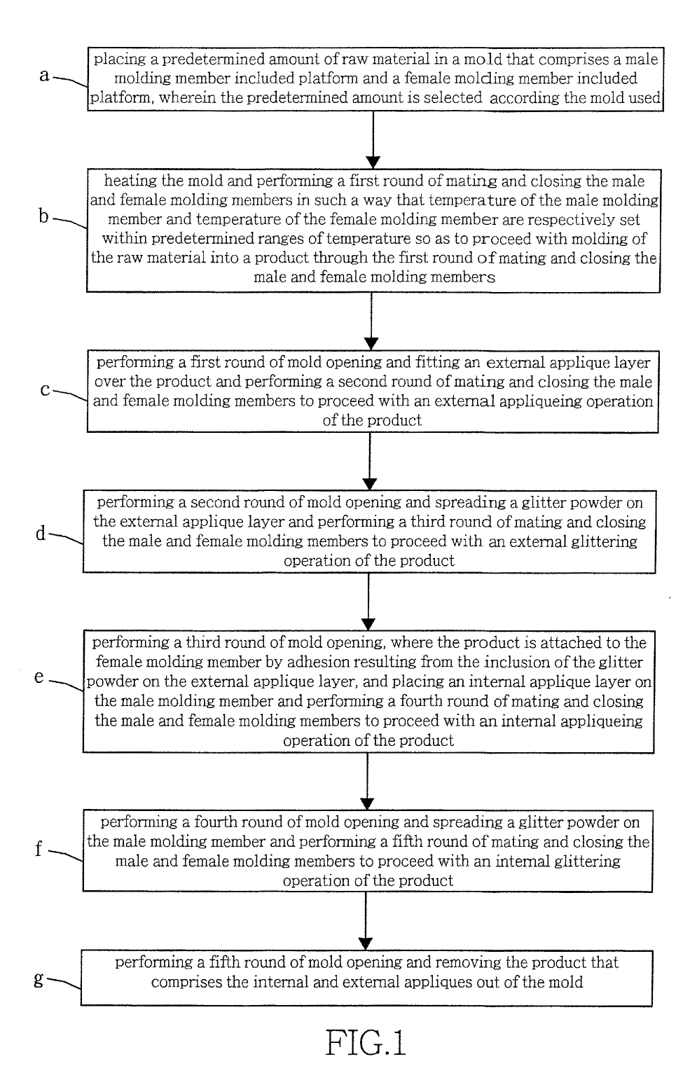

Referring to FIG. 1, which shows a flow chart of a method according to a preferred embodiment of the present invention, the drawing clearly shows the present invention comprises the following steps:
(a) placing a predetermined amount of raw material in a mold that comprises a male molding member included platform and a female molding member included platform, wherein the predetermined amount is selected according the mold used;
(b) heating the mold and performing a first round of mating and closing the male and female molding members in such a way that temperature of the male molding member and temperature of the female molding member are respectively set within predetermined ranges of temperature so as to proceed with molding of the raw material into a product through the first round of mating and closing the male and female molding members;
(c) performing a first round of mold opening and fitting an external applique layer over the product and performing a second round of mating and closing the male and female molding members to proceed with an external appliqueing operation of the product;
(d) performing a second round of mold opening and spreading a glitter powder on the external applique layer and performing a third round of mating and closing the male and female molding members to proceed with an external glittering operation of the product;
(e) performing a third round of mold opening, where the product is attached to the female molding member by adhesion resulting from the inclusion of the glitter powder on the external applique layer, and placing an internal applique layer on the male molding member and performing a fourth round of mating and closing the male and female molding members to proceed with an internal appliqueing operation of the product;
(f) performing a fourth round of mold opening and spreading a glitter powder on the male molding member and performing a fifth round of mating and closing the male and female molding members to proceed with an internal glittering operation of the product; and
(g) performing a fifth round of mold opening and removing the product that comprises the internal and external appliques out of the mold.

In the above-described operation, the temperature of the male molding member is set higher than the temperature of the female molding member by a temperature difference within a range of ±17 degrees Celsius.

In the above-described operation, the male and female molding members are subject to control of working or operation temperatures thereof by applying a hydraulically operated processing machine. In addition, the raw material is selected according to needs to change for example color or property.

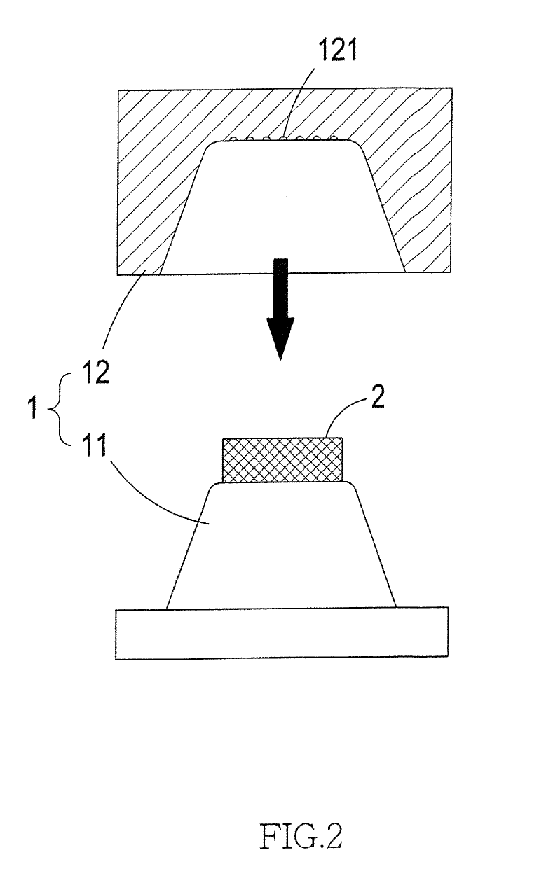

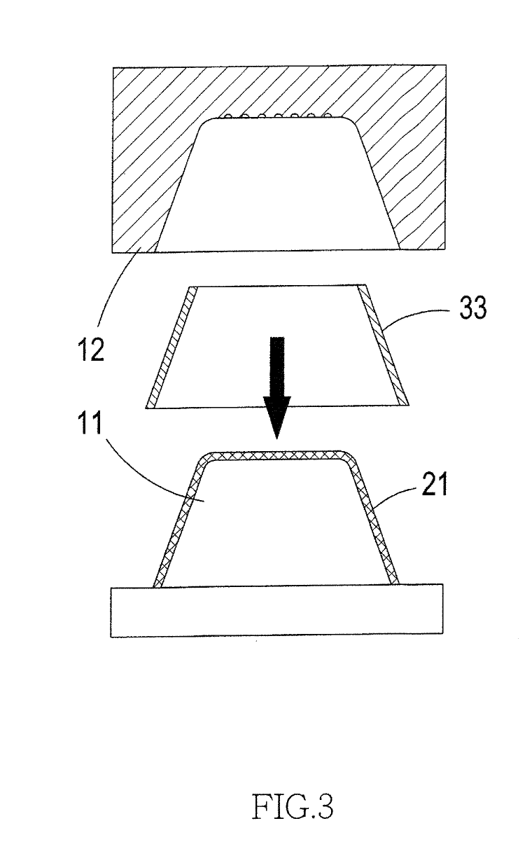

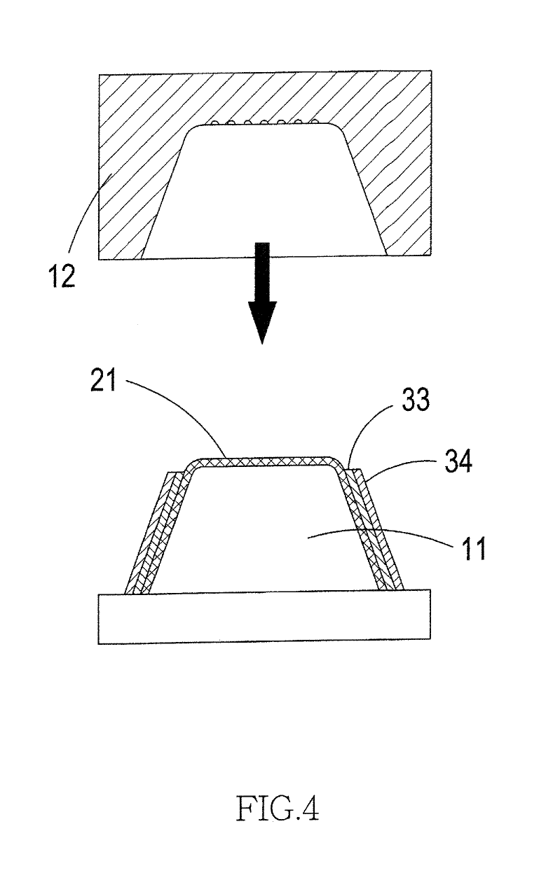

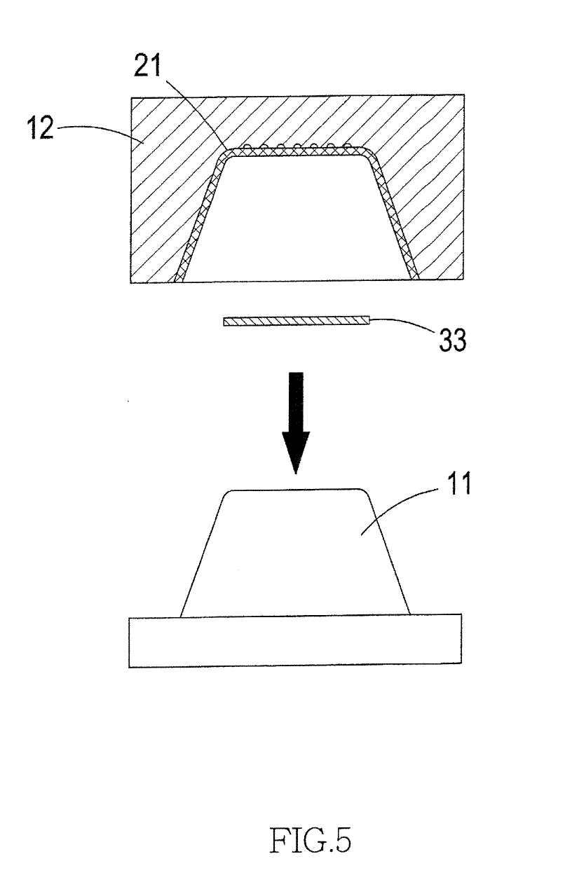

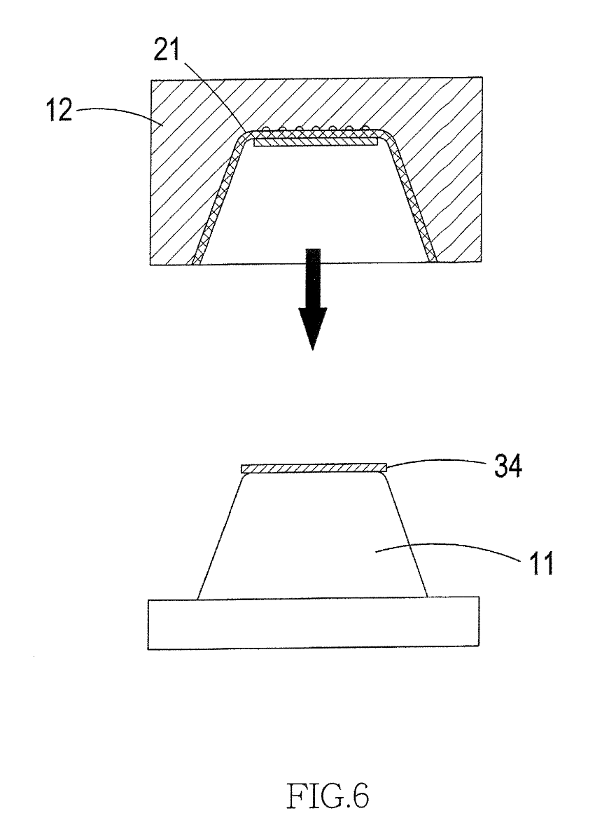

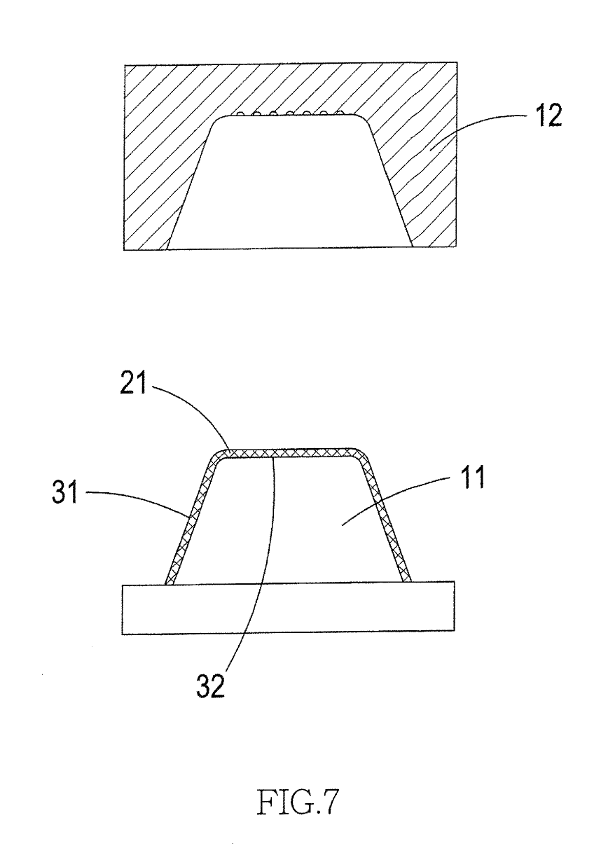

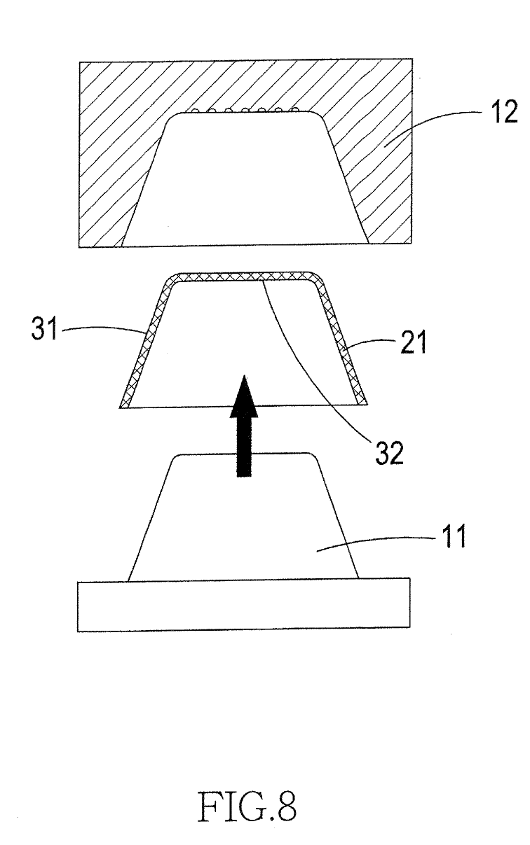

Reference is also made to FIGS. 2-8, which are cross-sectional views illustrating an example operation of the preferred embodiment of the present invention, the drawings clearly show that the hydraulically operated processing machine (not shown) is used to control the operation of the mold 1 before the raw material 2 is placed into the mold 1, so that the temperature of the male molding member 11 and the temperature of the female molding member 12 are kept at a difference within a range of ±17 degrees Celsius. After the heating is completed, the raw material 2 is placed into the male molding member 11 and the first round of mating and closing the male and female molding members is performed for molding a product 21. The raw material used can be selected according to the needs of an operator to change color or property thereof. When the product 21 is heated to a predetermined temperature, the product 21 gets partially hardened but still possesses certain adhesion, whereby when the mold 1 is opened, the product 21 will be kept on the male molding member 11 at least partially due to gravity thereof. Then, a pattern sheet 33 (which could be the external applique layer) placed on the product 21 and the second round of mating and closing the male and female molding members is performed. Afterwards, the mold is opened again and the glitter powder 34 is spread on the pattern sheet 33 and a third round of mating and closing the male and female molding members is performed to form the external applique layer 32 on the product. Then, the mold is opened again, due to recesses 121 formed in the female molding member and also due to the adhesion of the external applique layer 31, the product 21 is kept in the female molding member 12. Under this condition, where the product is separated from the male molding member, the male molding member is exposed so that another pattern sheet 33 (which could be the internal applique layer) is allowed to be placed on the male molding member 11. A fourth round of mating and closing the male and female molding member is then performed. The mold is then opened again and a glitter powder 34 is spread on the pattern sheet 33. (This is possibly done by placing the glitter powder 34 on the male molding member 11 when the mold is open and the product and said another pattern sheet are carried by the product so as to expose the male molding member, whereby an equivalent effect as spreading the glitter powder on the pattern sheet is accomplished). And, a fifth round of mating and closing the male and female molding members is performed to form the internal applique layer 32. After the fifth round of mating and closing the male and female molding members for heating and molding the product, the mold is opened again and the product 21, which comprises the internal and external applique layers attached thereto, is removed out of the mold. As such, a melamine container having internal and external applique layers can be manufactured. With the above described process, a single machine and a single mold can accomplish the purpose of molding and externally and internally appliqueing.

The technical features that the multi-surface appliqueing method for a melamine container adopts to overcome the shortcomings of the known techniques are as briefed as followed.

Proper control of temperature difference between the male and female molding member 11, 12, together with the collaboration between the recesses 121, the pattern sheets 33, and the glitter powders 34, a single machine and a mold 1 can be used to carry out multiple rounds of mating and closing male and female molding members, followed by timely opening the mold, molding and externally and internally appliqueing of a container or other product can be achieved by using a single mold. As such, the problems of the known techniques, such as being impossible to use a single machine to carry out a second round of molding, coating being readily peeled off and delaminated due to being not integrally formed, and waste of time and human labor, can be overcome.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-surface appliquieng method for a melamine container, comprising the following steps:
(a) placing a predetermined amount of raw material in a mold that comprises a male molding member included platform and a female molding member included platform, wherein the predetermined amount is selected according the mold used;
(b) heating the mold and performing a first round of mating and closing the male and female molding members in such a way that temperature of the male molding member and temperature of the female molding member are respectively set within predetermined ranges of temperature so as to proceed with molding of the raw material into a product through the first round of mating and closing the male and female molding members;
(c) performing a first round of mold opening and fitting an external applique layer over the product and performing a second round of mating and closing the male and female molding members to proceed with an external appliqueing operation of the product;
(d) performing a second round of mold opening and spreading a glitter powder on the external applique layer and performing a third round of mating and closing the male and female molding members to proceed with an external glittering operation of the product;
(e) performing a third round of mold opening, where the product is attached to the female molding member by adhesion resulting from the inclusion of the glitter powder on the external applique layer, and placing an internal applique layer on the male molding member and performing a fourth round of mating and closing the male and female molding members to proceed with an internal appliqueing operation of the product;
(f) performing a fourth round of mold opening and spreading a glitter powder on the male molding member and performing a fifth round of mating and closing the male and female molding members to proceed with an internal glittering operation of the product; and
(g) performing a fifth round of mold opening and removing the product that comprises the internal and external appliques out of the mold.

2. The method according to claim 1, wherein the temperature of the male molding member is different from the temperature of the female molding member by a range of ±17 degrees Celsius.

3. The method according to claim 1, wherein the temperatures of the male and female molding members are controlled by applying a hydraulically operated processing machine.

4. The method according to claim 1, wherein the raw material is selected according to need to change color or property.

5. The method according to claim 1, wherein the female molding member comprises recesses formed therein.
